(19) United States
(12) Patent Application Publication
(10) Pub. No.: US 2025/0307127 A1
(43) Pub. Date: Oct. 2, 2025

(54) TESTING AND DEPLOYMENT OF CONTAINERIZED APPLICATION USING SIDE-CAR CONTAINERS

(71) Applicant: Red Hat, Inc., Raleigh, NC (US)

(72) Inventors: Pierre-Yves Chibon, Saint-Pol-de-Léon (FR); Rachel Elizabeth Sibley, Raleigh, NC (US); Leigh Griffin, Waterford (IE)

(21) Appl. No.: 18/617,342

(22) Filed: Mar. 26, 2024

(51) Int. Cl. G06F 11/36

(52) U.S. Cl. CPC G06F 11/3698

(57) ABSTRACT

A method includes identifying a code testing tool associated with an application within a first container, deploying the code testing tool to a second container separate from the first container, and performing a test of the application within the first container using the code testing tool deployed to the second container.

### TECHNICAL FIELD

Aspects of the present disclosure relate to testing of containerized applications, and more particularly, using a side-car container for testing and deployment of containerized applications.

### BACKGROUND

A container-orchestration system may be a platform for developing and running containerized applications and may allow applications and the data centers that support them to expand from just a few machines and applications to thousands of machines that serve millions of clients. Container-orchestration system may provide an image-based deployment module for creating containers and may store one or more image files for creating container instances. Many application instances can be running in containers on a single host without visibility into each other's processes, files, network, and so on. Each container may provide a single function (often called a “service”) or component of an application, such as a web server or a database, though containers can be used for arbitrary workloads.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates an example system for testing and deploying a containerized application, in accordance with some embodiments.

FIG. 2 is a block diagram that illustrates another example of a system for testing a containerized application using a side-care container, in accordance with embodiments of the disclosure.

FIG. 3 is a block diagram of an example a computing system testing a containerized application, in accordance with some embodiments.

FIG. 4 is a flow diagram of a method of testing a containerized application using a separate container, in accordance with some embodiments.

FIG. 5 depicts a flow diagram of another method of testing a containerized application using a side-car container, in accordance with some embodiments.

FIG. 6 is a block diagram of an example apparatus that may perform one or more of the operations described herein, in accordance with some embodiments of the present disclosure.

### DETAILED DESCRIPTION

Testing of an application within a container includes building the application within the container and testing capabilities the application using a set of predesigned tests and test data, depending on the type of application. In conventional systems for testing applications within a container, the test tooling must be deployed within the same container to allow the test tools access to the application during execution. For example, to perform a test of an application, current systems deploy testing tools, capabilities, and test suites into the same container in which the application is deployed. Accordingly, after validation of the application and the container, conventions systems must rebuild the container without the tooling that was incorporated in the container for testing in order to deploy the container to production. Such processes consumes unnecessary resources and time, thus reducing the ability to quickly test and release containerized applications. Furthermore, such conventions systems inherently do not allow for shipping the same product (e.g., container) as was tested because the container includes additional resources during testing. Thus, a modified copy is tested rather than the exact container that will operate in a production environment. Therefore, the footprint of the containerized application cannot be accurately tests which may be necessary in cases where the container footprint should be small, such as in Edge Computing environments.

Aspects of the disclosure address the above-noted and other deficiencies by providing a mechanism for testing containerized applications from a separate container, such as a side-car container. In some embodiments, a side-car container may include a testing component for identifying a test plan for an application deployed to a container, retrieve the necessary test tooling, data, etc. to execute the test plan. For example, the testing component may query or scan the application container to determine information associated with the application, such as a type of the application, size of the application, and other metadata associated with the application. The testing component may then identify a test plan corresponding to the type, size, etc. of the application and then identify one or more testing tools or resources for performing the test plan. The testing component may pull the one or more identified testing tools or resources from a testing repository (e.g., a centralized repository storing various testing tools and resources for testing software applications). In some embodiments, the testing component may initialize the retrieved testing tools, resources, datasets, etc. in the side-car container. Because the side-car container has pod-wide visibility and thus visibility into the application container, the testing component of the side-car container may use the retrieved testing tools, etc. to externally perform one or more tests on the application according to the test plan.

By providing a mechanism to externally test application containers, embodiments may allow testing of the exact container that will be provided to production. Accordingly, containerized applications may be tested more accurately and prevent unexpected footprint restrictions or similar unintended operation. Furthermore, embodiments may reduce resource consumption as well as the time to product release by avoiding the additional steps of deploying and removing the test tooling to the application container.

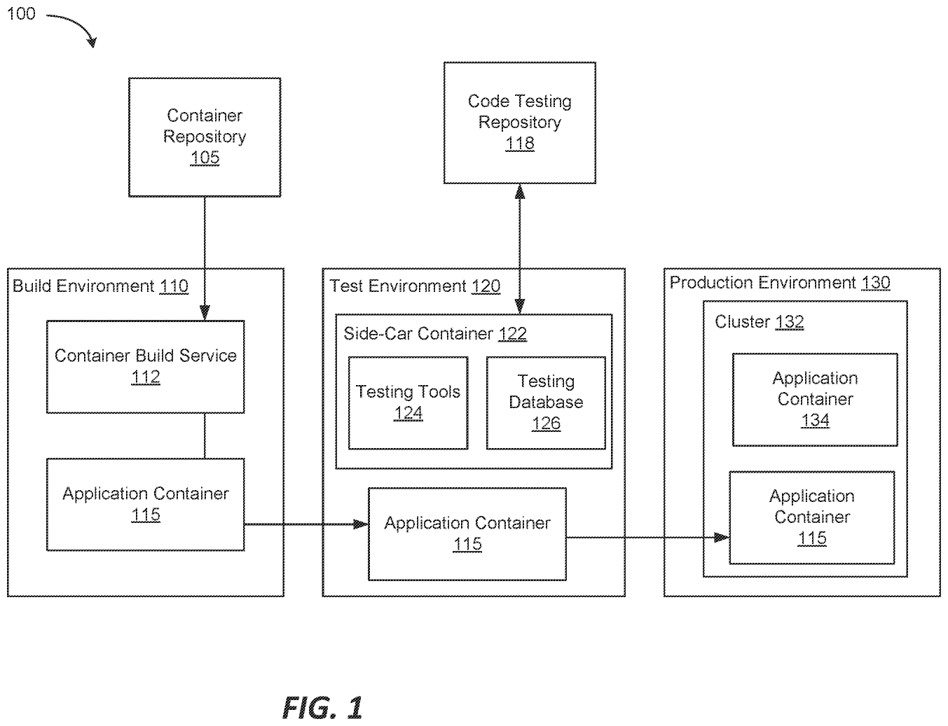

FIG. 1 is a block diagram illustrating a container application development and testing system 100, according to some embodiments. The system 100 includes a build environment 110 and a test environment 120 from which an application container 115 may be developed, built, and tested before deploying the application container to a production environment 130. The build environment 110 may include a container build service 112 for identifying and retrieving a container image from a container repository 105. A container repository may be storage, data store, database, etc. in which container images may be saved, stored, and retrieved to be instantiated within an execution environment. In some embodiments, the build environment 110 may receive a request (e.g., from a developer) to build a selected container including a particular application (e.g., an application or portions of an application, that executes within a container). In some embodiments, a container may be an isolated sandbox environment in which applications may be deployed and tested without exposure to an external environment. Accordingly, the container build service 112 may obtain the container image corresponding to the selected container and build that application container 115 from the obtained container image. The container image may include one or more applications and all dependencies and resource allocations required to execute the one or more applications.

In some examples, upon completion of the build of the application container 115 within the build environment 110, the application container 115 may be provided to a test environment 120. In some examples, the build environment 110 and the test environment 120 are the same platform and environment but at different stages of operation (e.g. build and test). In some examples, the test environment 120 may include a pod of containers including a side-car container 122 which may have visibility into the application container 115. In some embodiments, the side-car container 122 may include logic to query or scan the application container 115 to determine the application or applications running in the container. The side-car container 122 may then identify and obtain testing tools 124 and testing database 126 along with any other testing dependencies or resources from the code testing repository 118. Code testing repository 118 may be centralized and network accessible storage, a data store, a server, etc. for storing and retrieving code testing tools. The side-car container 122 may further include logic to execute one or more tests of the operation of the application container 115 using the testing tools 124 and testing database 126. Because the side-car container 122 has visibility into the application container 115 which may be deployed within the same pod, the side-car container 122 may perform each of the tests externally to the application container 115. Although embodiments are described herein as providing a single side-car container, any number of side-car containers may be instantiated for retrieving and performing tests on an application container. For example, the number and arrangement of the side-car containers may depend on the configurations required by configurations required by the testing tools for performing the one or more tests of the application container.

Upon completion of the one or more tests by the side-car container 122, the application container 115 may be provided to a production environment 130 for deployment. In some embodiments, the application container 115 may be deployed to a cluster 132 of computing nodes (e.g., virtual machines, servers, cloud computing environment, etc.). Because the testing tools 124, testing database 126, and other resources are deployed to the side-car container 122 during testing, rather than within the application container 115 itself, the exact same application container 115 that was tested may be deployed to the production environment 130. Therefore, the same operation and footprint that were tested are deployed, avoiding unknown or unexpected behaviors when deployed. In some embodiments, multiple instances of the application container 115 may be instantiated within the cluster 132. In some embodiments, various different application containers (e.g., application container 134) may be deployed within the same cluster 132. Accordingly, the application of the application container 115 may be scaled up or down as needed and also used in combination with the functionality of other applications deployed to the cluster 132.

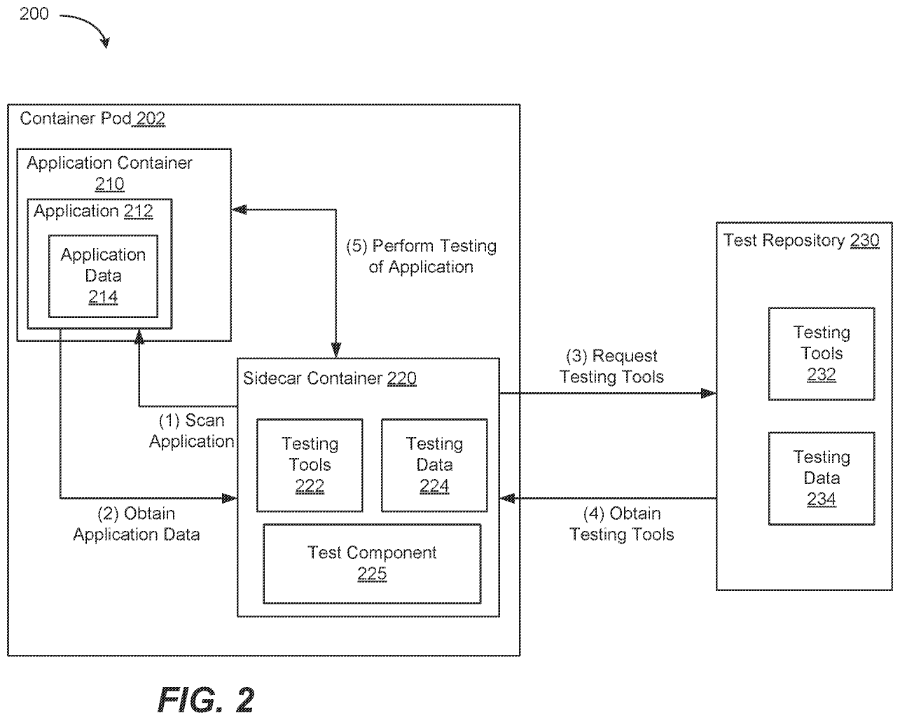

FIG. 2 is a block diagram that illustrates a container application testing system 200, according to some embodiments. As depicted, system 200 includes a pod of containers 202 including at least an application container 210 and a side-car container 220. In some examples, the application container 210 may include an application 212 or one or more processes of an application. An application may include a collection of one or more containerized processes for performing functions and services of the application. The side-care container 220 may include a test component 225 for performing the operations described herein. In some embodiments, the side-car container 220 (e.g., via the test component 225) may query or otherwise scan the application container 210 for application data 214 indicating an identification or type of the application 212 executing within the application container 210. In some examples, the test component 225 may obtain the application data 214 and determine a test plan for the application 212 based on the application data 214. For example, the test component 225 may identify one or more steps of testing to be performed on the application 212 depending on what the application 212 is and what functionality is performed by the application 212.

Upon determining the test plan for the application 212, the test component 225 may identifying which testing tools, resources, dependencies, etc. are needed to implement the test plan. The test component 225 may then request the identified test tooling from a test repository 230 storing various software testing resources (e.g., testing tools 232 and testing data 234). The test component 225 may obtain the testing tools 222 and testing data 224 from the test repository 230 and initialize them within the side-car container 220. After initialization of the testing resources at the side-car container 220, the test component 225 may perform one or more tests of the application 212 within the application container 210 using the testing tools 222 and testing data 224 along with any other test dependencies that were retrieved from the test repository 230. The test component 225 may further provide an indication of the results of the one or more tests performed on the application 212. Upon successful testing, the application container 210 may be provided to a production environment for execution without any changes to the application container 210.

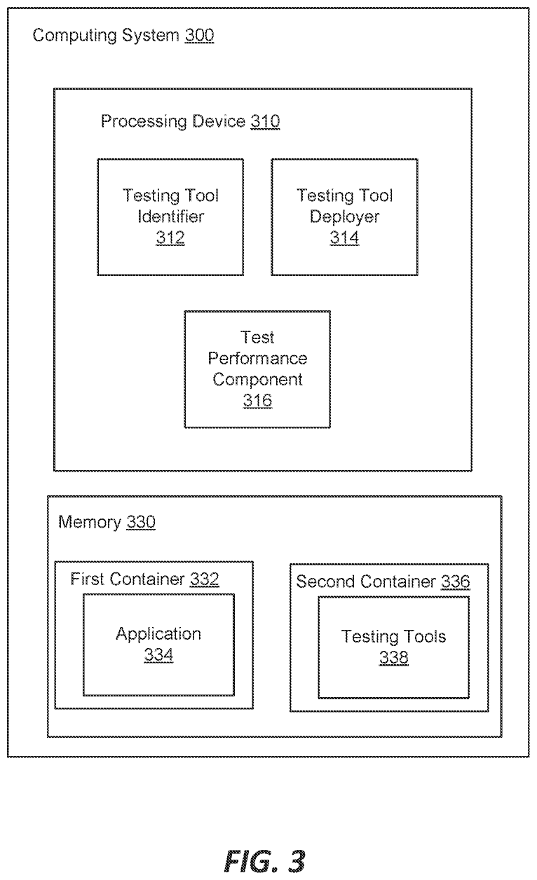

FIG. 3 is a block diagram illustrating a computing system 300 for testing a containerized application, according to some embodiments. Computing system 300 includes processing device 310 and memory 330. Memory 330 may include volatile memory devices (e.g., random access memory (RAM)), non-volatile memory devices (e.g., flash memory) and/or other types of memory devices.

The processing device 310 may be provided by one or more general-purpose processing devices such as a microprocessor, central processing unit, or the like. In some embodiments, processing device 310 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 310 may be configured to execute the operations described herein, in accordance with one or more aspects of the present disclosure, for performing the operations and steps discussed herein. For example, processing device 310 may execute a testing tool identifier 312, testing tool deployer 314, and test performance component 316.

In one example, testing tool identifier 312 may scan an application 334 of a first container 332 to determine information associated with the application 334. For example, the testing tool identified 312 may determine an identify or type of the application 334, such as a functionality of the application. In some examples, the testing tool identifier 312 may further determine, based on the identity or type of the application 334, a test plan for the application which tests the identified functionality. The test plan may include executing one or more tests via particular testing tools. Accordingly, the testing tool identifier 312 may identify which testing tools are needed to perform the test plan. In some examples, the testing tool deployer 314 may retrieve the identified testing tools from a centralized test repository. Additionally, the testing tool deployer 314 may retrieve any dependencies and resources, such as test data sets, upon which the retrieved testing tools rely. The testing tool deployer 314 may then initialize or otherwise deploy the testing tools (e.g., testing tools 338) to a second container 336. The second container 336 may be a separate container within the same pod of the first container 332. In some examples, the second container 336 may be a side-car container for executing services that support operation of the first container 332. Accordingly, the second container 336 may have visibility and access to the first container to perform the one or more test using the testing tools 338. In some embodiments, the test performance component 316 may initiate performance of the one or more tests of the application 334 using the testing tools 338.

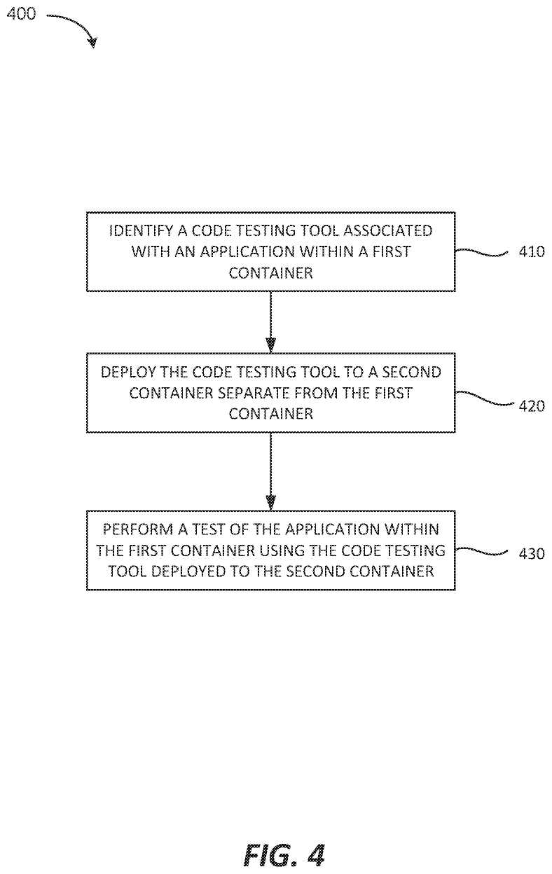

FIG. 4 is a flow diagram of a method 400 of externally testing an application container, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by test component 225 of FIG. 2.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic identifies a code testing tool associated with an application within a first container. For example, processing logic may scan the first container for information associated with the application within the first container, determine a test plan in view of the information associated with the application, and identify the code testing tool in view of the test plan.

At block 420, the processing logic deploys the code testing tool to a second container separate from the first container. In some examples, the second container includes a side-car container with access to the first container and that is accessible by the first container. The first and second containers may each be included within a pod of containers. In some examples, the processing logic may retrieve the code testing tool from a central repository including various code testing tools.

At block 430, the processing logic performs a test of the application within the first container using the code testing tool deployed to the second container. In some embodiments, the processing logic executes the application with test data from the second container and monitors the application by the second container using the code testing tool. In response to successful completion of the test of the application, processing logic may provide the first container including the application to a production environment without changes to the first container.

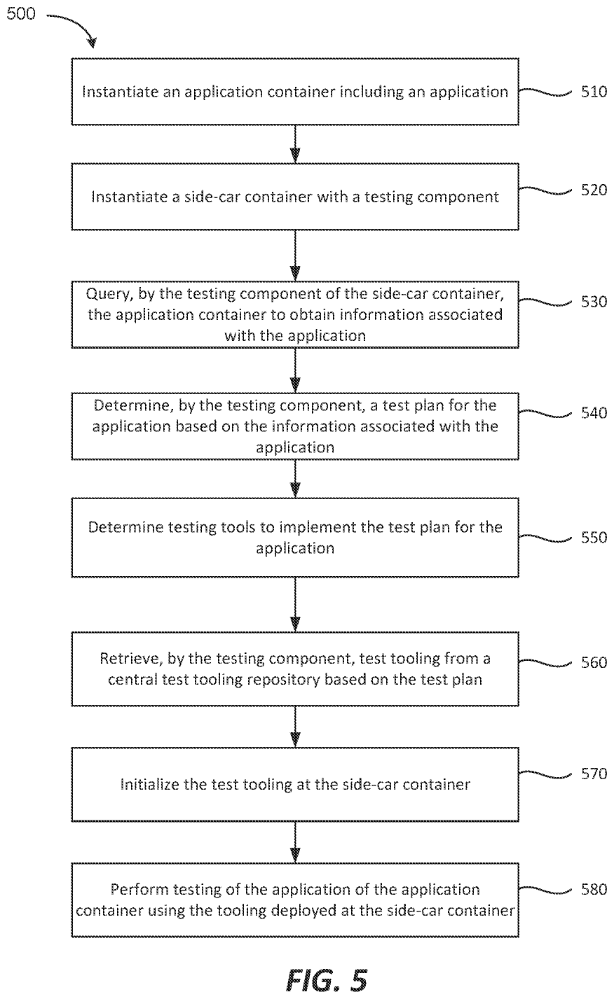

FIG. 5 is a flow diagram of a method 500 of externally testing an application container using a side-car container, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by test component 225 of FIG. 2.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 510, where the processing logic instantiates an application container including an application. The application may include a collection of one or more containerized processes for performing functions and services of the application. In some examples, the application container may be instantiated from a container image. The container image may be pulled from a container image repository storing various container images.

At block 520, the processing logic instantiates a side-car container with a testing component. The side-car container may be a container generated for supporting one or more other containers within the same pod of containers. For example, the side-car container may not include any application logic, but rather includes a testing component which manages testing of the application in the application container. In some examples, multiple side-car containers may be instantiated for testing the application container.

At block 530, the processing logic queries, by the testing component of the side-car container, the application container to obtain information associated with the application. For example, the testing component may scan the application of the application container to identify information about the application. In some examples, the application information may include an identification of the application, a type of the application, a functionality of the application, or any other information that is informative of what testing should be performed on the application.

At block 540, the processing logic determines, by the testing component, a test plan for the application based on the information associated with the application. The test plan may include one or more steps for testing whether the application performs the intended functionality.

At block 550, the processing logic determines testing tools to implement the test plan for the application. For example, the testing component may identify testing tools for performing each of the steps of the test plan identified by the testing component to adequately test operation of the application. In some embodiments, the testing component of an original side-car container may determine if additional side-car containers are to be instantiated to support a configuration of the testing tools identified from the test plan. For example, the testing component may determine that the required configurations for the testing tools may different from one another and therefore cannot share a container. Thus, additional side-car containers may be instantiated to support all of the test tools identified for the testing plan.

At block 560, the processing logic retrieves, by the testing component, test tooling from a central test tooling repository based on the test plan. The central test repository may store various testing tools and resources for performing testing of various types of applications, processes, functions, etc. The processing logic may retrieve the previously identified testing tools and all dependencies and resources associated with the testing tools.

At block 570, the processing logic initializes the test tooling at the side-car container. For example, the testing component may download and install the test tooling to the side-car container from the repository. The testing component may then execute the test tooling according to the test plan identified above. At block 580, the processing logic performs testing of the application in the application container using the tooling deployed at the side-car container.

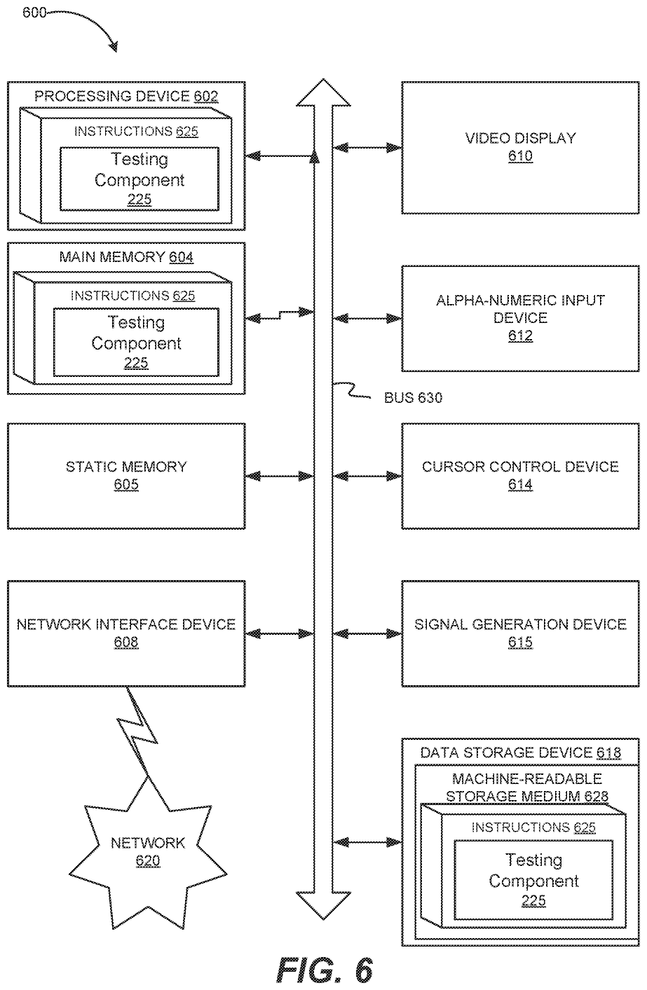

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a test component, e.g., test component 225 of FIG. 2, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “identifying,” “deploying,” “performing,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
identifying a code testing tool associated with an application within a first container;
deploying the code testing tool to a second container separate from the first container; and
performing, by a processing device, a test of the application within the first container using the code testing tool deployed to the second container.

2. The method of claim 1, wherein identifying the code testing tool associated with the application, comprises:
scanning the first container for information associated with the application within the first container;
determining a test plan in view of the information associated with the application; and
identifying the code testing tool in view of the test plan.

3. The method of claim 1, wherein the second container comprises a side-car container accessible by the first container.

4. The method of claim 1, further comprising:
retrieving the code testing tool from a central repository comprising a plurality of code testing tools.

5. The method of claim 1, wherein the first and second container are included within a pod of containers.

6. The method of claim 1, wherein performing the test of the application within the first container using the code testing tool deployed to the second container, comprises:
executing the application with test data from the second container; and
monitoring the application by the second container using the code testing tool.

7. The method of claim 1, further comprising:
in response to successful completion of the test of the application, providing the first container including the application to a production environment without changes to the first container.

8. A system comprising:
a memory; and
a processing device operatively coupled to the memory, the processing device to:
identify a code testing tool associated with an application within a first container;
deploy the code testing tool to a second container separate from the first container; and
perform a test of the application within the first container using the code testing tool deployed to the second container.

9. The system of claim 8, wherein to identify the code testing tool associated with the application, the processing device is to:
scan the first container for information associated with the application within the first container;
determine a test plan in view of the information associated with the application; and
identify the code testing tool in view of the test plan.

10. The system of claim 8, wherein the second container comprises a side-car container accessible by the first container.

11. The system of claim 8, wherein the processing device is further to:
retrieve the code testing tool from a central repository comprising a plurality of code testing tools.

12. The system of claim 8, wherein the first and second container are included within a pod of containers.

13. The system of claim 8, wherein to perform the test of the application within the first container using the code testing tool deployed to the second container, the processing device is to:
execute the application with test data from the second container; and
monitor the application by the second container using the code testing tool.

14. The system of claim 8, wherein the processing device is to:
in response to successful completion of the test of the application, provide the first container including the application to a production environment without changes to the first container.

15. A non-transitory computer-readable storage medium including instructions that, when executed by a processing device, cause the processing device to:
identify a code testing tool associated with an application within a first container;
deploy the code testing tool to a second container separate from the first container; and
perform, by the processing device, a test of the application within the first container using the code testing tool deployed to the second container.

16. The non-transitory computer-readable storage medium of claim 15, wherein to identify the code testing tool associated with the application, the processing device is to:
scan the first container for information associated with the application within the first container;
determine a test plan in view of the information associated with the application; and
identify the code testing tool in view of the test plan.

17. The non-transitory computer-readable storage medium of claim 15, wherein the second container comprises a side-car container accessible by the first container.

18. The non-transitory computer-readable storage medium of claim 15, wherein the processing device is further to:
retrieve the code testing tool from a central repository comprising a plurality of code testing tools.

19. The non-transitory computer-readable storage medium of claim 15, wherein to perform the test of the application within the first container using the code testing tool deployed to the second container, the processing device is to:
execute the application with test data from the second container; and
monitor the application by the second container using the code testing tool.

20. The non-transitory computer-readable storage medium of claim 15, wherein the processing device is to:
in response to successful completion of the test of the application, provide the first container including the application to a production environment without changes to the first container.
